(19) United States
(12) Patent Application Publication
(10) Pub. No.: US 2025/0117450 A1
(43) Pub. Date: Apr. 10, 2025

(54) SYSTEMS AND METHODS FOR OBFUSCATING AN ACCESSIBILITY ELEMENT USING DIGITAL RIGHTS MANAGEMENT ("DRM") PROTECTIONS

(71) Applicant: Capital One Services, LLC, McLean, VA (US)

(72) Inventors: John Casey SMITH, Richmond, VA (US); Shahalam BAIG, Rochester, NY (US); Matthew HUNSBERGER, Hoboken, NJ (US)

(73) Assignee: Capital One Services, LLC, McLean, VA (US)

(21) Appl. No.: 18/905,198

(22) Filed: Oct. 3, 2024

Related U.S. Application Data
(60) Provisional application No. 63/587,891, filed on Oct. 4, 2023.
(60) Provisional application No. 63/665,485, filed on Jun. 28, 2024.
(60) Provisional application No. 63/683,063, filed on Aug. 14, 2024.

(51) Int. Cl. G06F 21/10; G06F 3/0483

(52) U.S. Cl. CPC G06F 21/101; G06F 3/0483

(57) ABSTRACT

Described are systems and methods for obfuscating an accessibility element using digital rights management (“DRM”) protections, including determining, via an application server, the accessibility element is associated with a first content element, receiving, via a first graphical user interface (“GUI”), at least one user input associated with the accessibility element or the first content element, wherein the at least one user input includes at least one of hovering, selecting, or clicking, modifying, via the application server, a HyperText Markup Language (“HTML”) associated with the first content element to remove the accessibility element, and causing to output, via the first GUI, the modified first content element such that the accessibility element is no longer caused to be output.

### CROSS-REFERENCE TO RELATED APPLICATION(S)

This application claims the benefit of U.S. Provisional Patent Application No. 63/587,891, filed on Oct. 4, 2023, U.S. Provisional Patent Application No. 63/665,485, filed on Jun. 28, 2024, and U.S. Provisional Patent Application No. 63/683,063, filed on Aug. 14, 2024, all of which are incorporated herein by reference in their entireties.

### TECHNICAL FIELD

Various embodiments of this disclosure relate generally to obfuscating an accessibility element using digital rights management (“DRM”) protections and, more particularly, to systems and methods for obfuscating an accessibility element using DRM protections by removing an Accessible Rich Internet Applications (“ARIA”) from a Document Object Model (“DOM”).

### BACKGROUND

Organizations such as banks and healthcare providers seek to protect sensitive or confidential information (e.g., personally identifiable information (“PII”), financial information, medical information, etc.) from social engineers. A social engineer is a person or entity who seeks to manipulate a target (e.g., a customer or employee of an organization) into divulging sensitive information that may be used for fraudulent purposes. That is, a social engineer is a person or entity who engages in social engineering. For example, when the target is a user who uses a display screen (also referred to herein as a “screen”) of a computing device to view an account number on a bank's website, a social engineer using another computing device may attempt to persuade the user to reveal the account number to the social engineer. More specifically, the social engineer may convince the user to (i) share the user's screen (displaying the account number) with the social engineer using a screen sharing or remote desktop application, or (ii) take a screenshot of the user's screen (displaying the account number) using a screenshotting application, and then transmit the screenshot to the social engineer.

To guard against such social engineering, the bank may employ digital rights management (“DRM”) technologies, which are technologies that limit the use of digital content. However, current DRM technologies may not be configured to protect sensitive information that may be accessible via an accessibility element.

This disclosure is directed to addressing one or more of the above-referenced challenges. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to certain aspects of the disclosure, methods and systems are disclosed for obfuscating an accessibility element using DRM protections.

In one aspect, a method for obfuscating an accessibility element using digital rights management (“DRM”) protections is disclosed. The method may include determining, via an application server, the accessibility element is associated with a first content element, receiving, via a first graphical user interface (“GUI”), at least one user input associated with the accessibility element or the first content element, wherein the at least one user input includes at least one of hovering, selecting, or clicking, modifying, via the application server, a HyperText Markup Language (“HTML”) associated with the first content element to remove the accessibility element, and causing to output, via the first GUI, the modified first content element such that the accessibility element is no longer caused to be output.

In another aspect, a system is disclosed. The system may include at least one memory storing instructions and at least one processor operatively connected to the memory, and configured to execute the instructions to perform operations for obfuscating an accessibility element DRM protections. The operations may include determining, via an application server, the accessibility element is associated with a first content element, receiving, via a first graphical user interface (“GUI”), at least one user input associated with the accessibility element or the first content element, wherein the at least one user input includes at least one of hovering, selecting, or clicking, modifying, via the application server, a HTML associated with the first content element to remove the accessibility element, and causing to output, via the first GUI, the modified first content element such that the accessibility element is no longer caused to be output.

In another aspect, a method for obfuscating an accessibility element using digital rights management (“DRM”) protections is disclosed. The method may include determining, via an application server, the accessibility element is associated with a first content element by scanning a HTML associated with the first content element to detect at least one of alternative text (“AltText”), accessibility text, semantic HTML, or a heading, detecting, via the application server, at least one of: (i) initiation of at least one HTML modification event, wherein the at least one HTML modification event includes at least one JavaScript event, wherein the at least one JavaScript event includes at least one of window focus, window blur, JavaScript editing pane activation, JavaScript editing pane deactivation, JavaScript editing pane width change, or JavaScript editing pane height change, or (ii) receipt, via a first graphical user interface (“GUI”), at least one user input associated with the accessibility element or the first content element, wherein the at least one user input includes at least one of hovering, selecting, or clicking, modifying, via the application server, the HTML associated with the first content element to remove the accessibility element by removing an ARIA from a DOM associated with the HTML, causing to output, via the first GUI, the modified first content element such that the accessibility element is no longer caused to be output, detecting an end event, wherein the end event includes cessation of at least one of: (i) the at least one HTML modification event or (ii) the at least one user input, upon detecting the end event, modifying the HTML associated with the modified first content element to insert the accessibility element to generate a modified second content element via the application server, and causing to output, via the first GUI, the modified second content element such that the accessibility element is caused to be output.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary environment for obfuscating an accessibility element using DRM protections, according to one or more embodiments.

FIG. 2 depicts an exemplary method for obfuscating an accessibility element using DRM protections, according to one or more embodiments.

FIG. 3 depicts a simplified functional block diagram of a computer, according to one or more embodiments.

### DETAILED DESCRIPTION OF EMBODIMENTS

Reference to any particular activity is provided in this disclosure only for convenience and not intended to limit the disclosure. The disclosure may be understood with reference to the following description and the appended drawings, wherein like elements are referred to with the same reference numerals.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” means “based at least in part on.” The singular forms “a,” “an,” and “the” include plural referents unless the context dictates otherwise. The term “exemplary” is used in the sense of “example” rather than “ideal.” The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. The term “or” is used disjunctively, such that “at least one of A or B” includes, (A), (B), (A and A), (A and B), etc. Relative terms, such as, “substantially,” “approximately,” “about,” and “generally,” are used to indicate a possible variation of ±10% of a stated or understood value.

It will also be understood that, although the terms first, second, third, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

The term “user” or the like may refer to a person authorized to access an account, attempting to access an account, etc. As used herein, the term “social engineer” may be a person or entity who seeks to manipulate a target (e.g., a customer or employee of an organization) into divulging sensitive information that may be used for fraudulent purposes. That is, a social engineer is a person or entity who engages in social engineering.

As used herein, the phrase “media content” may represent a browser, a website, a webpage, etc. As used herein, the phrase “content element” may represent text data (e.g., letters, numbers, symbols, metadata, or alt text), image data (e.g., an image, a graphic, a sequence of image frames, or a video), audio data (e.g., a sequence of audio frames), or video data (e.g., a sequence of image frames). Further, a content element may represent data included in, or referred by, an HTML element of an HTML page corresponding to (or representing) the webpage. For example, a content element may be included in HTML used to structure the website, such as a Document Object Model (“DOM”), Cascading Style Sheets (“CSS”), etc. In some aspects, the content element may include or represent sensitive or confidential information (e.g., that may be displayed on a webpage (or webpage(s), website(s), portal(s) or application(s), etc.).

As used herein, the phrase “sensitive information” or “sensitive data” may refer to data that is intended for, or restricted to the use of, one or more users or entities (e.g., a user 105, an organization associated with a DRM-protection system 131, etc.). Moreover, sensitive data may represent data that is personal, private, confidential, privileged, secret, classified, or in need of protection, for example. Sensitive information may include personally identifiable information (“PII”) (e.g., a name, an address, a phone number, a social security number, etc.), financial information (e.g., an account number, an account balance, debits, credits, etc.), medical information (e.g., test results, appointments, medications, etc.), business information (e.g., proprietary information, trade secrets, etc.), government information (e.g., classified or secret information), any information a user may wish to not be shared with a third party, etc.

The phrase “hypertext markup language,” “HTML,” or the like may refer to a standardized system for tagging text files to achieve font, color, graphic, or hyperlink effects on World Wide Web pages. The phrase “HTML element” may represent a component of an HTML page, and may include, for example, a start tag and end tag, and as noted above, a content element or a reference to a content element (e.g., link, hyperlink, address, or path to a content element). Further, in some embodiments, an HTML element may include one or more HTML elements (e.g., nested HTML elements). As used herein, the term “pixel” may refer to the smallest element (or unit) of a display screen that can be programmed by (or manipulated through) software. In some embodiments, a pixel may include sub-pixels (e.g., a red sub-pixel, a green sub-pixel, and a blue sub-pixel) that emit light to create a color displayed on the display screen. In some aspects, the color may be included in, or represent, text data, image data, or video data presented on the display screen.

As used herein, the phrase “digital extraction” may refer to any process of copying content (e.g., audio, video, text, image, etc.), such as ripping, screensharing, screenshotting, etc. As used herein, the term “screenshare” or “screen share” may refer to a real time or near real time electronic transmission of data displayed on a display screen of a user's computing device to one or more other computing devices. The term “screensharing” or “screen sharing” and the phrase “being screenshared” or “being screen shared” may refer to performing a screenshare. In some aspects, screensharing may be performed using a screensharing application (e.g., a video or web conferencing application such as Zoom®, Microsoft's Teams®, or the like, or a remote desktop application such as Microsoft Remote Desktop, Chrome Remote Desktop, or the like). As used herein, the term “screenshot” or “screen shot” may represent an image of data displayed on a display screen of a computing device, where the image may be captured or recorded. The term “screenshotting” or “screen shotting” and the phrase “being screenshotted” or “being screen shotted” may refer to capturing or recording a screenshot. In some aspects, screenshotting may be performed using a screenshotting application (e.g., the Snipping Tool in Microsoft Windows 11® or an application accessed using a Print Screen key of a keyboard or keypad).

In an exemplary use case, a user may wish to protect accessibility-enabled sensitive information using DRM protections. The system (as described below) may determine an accessibility element is associated with a content element, and may remove the accessibility element if digital extraction, at least one user input, or an HTML modification event are determined. The accessibility element may be removed from the HTML (e.g., from the DOM of the HTML). The modified content element (e.g., the content element modified to remove the accessibility element) may be caused to be output via a graphical user interface (“GUI”) such that the accessibility element is not caused to be output (e.g., is not associated with the content element).

In some embodiments, where it is determined that digital extraction, at least one user input, or an HTML modification event are no longer indicated (e.g., that the sensitive information may no longer be at risk), the modified content element may be modified again to insert the accessibility element. The content element with the inserted accessibility element may be caused to be output via the GUI such that the accessibility element is caused to be output (e.g., is associated with the content element). In this way, a social engineer may not be able to circumvent DRM protections by utilizing accessibility elements.

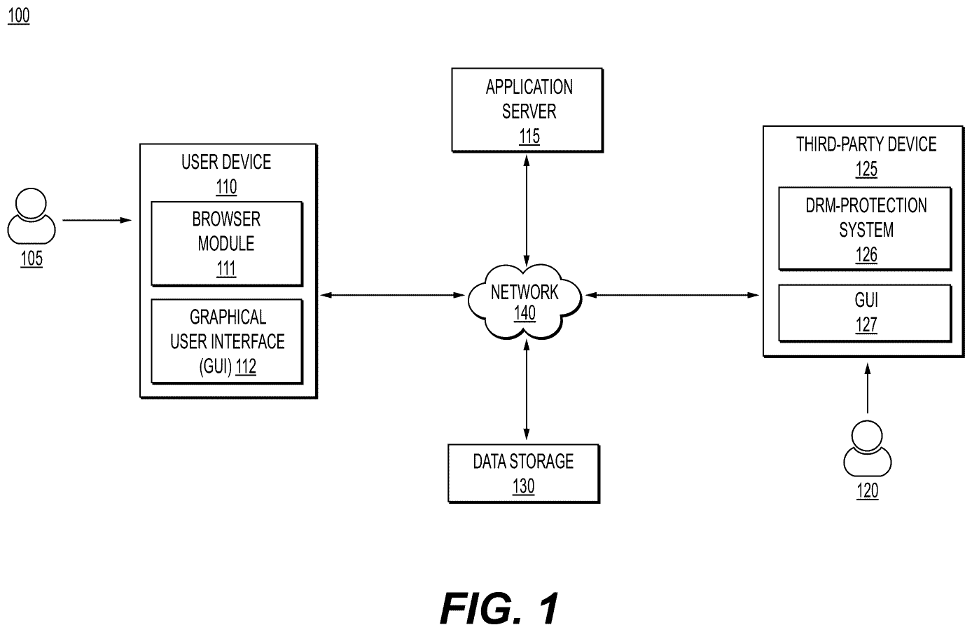

FIG. 1 depicts an example environment 100 that may be utilized with techniques presented herein. In some aspects, the environment 100 may be an embodiment of (i) environment 100 described in U.S. Provisional Application 63/587,891, filed on Oct. 4, 2023, (ii) environment 100 described in U.S. Provisional Application 63/665,485, filed on Jun. 28, 2024, or (iii) environment 100 described in U.S. Provisional Patent Application No. 63/683,063, filed Aug. 14, 2024 where each of these U.S. provisional applications is incorporated by reference herein in its entirety. FIG. 1 depicts an exemplary environment 100 for obfuscating an accessibility element using digital rights management (“DRM”) protections, according to one or more embodiments. Environment 100 may include one or more aspects that may communicate with each other over a network 140, including, e.g., at least one memory storing instructions, and at least one processor operatively connected to the at least one memory and configured to execute the instructions to perform operations for generating a DRM-protected media input field.

In some embodiments, a user 105 may interact with a user device 110 such that media content (e.g., a browser, a website, a webpage, etc.) including at least one content element may be loaded. As depicted in FIG. 1, a user 105 may be an individual authorized to use, access, etc. user device 110 or access, view, etc. sensitive information. User device 110 may interact with at least one of an application server 115, a third-party device 125, a data storage 130, etc. User device 110 may be configured to enable user 105 to access or interact with other systems in environment 100.

In some embodiments, a third-party user 120 may interact with a third-party device 125 such that information associated with at least one user input may be managed. A third-party user 120 may be an individual associated with a third party, such as a third party facilitating, monitoring, etc. the DRM protections discussed herein. Third-party device 125 may be configured to enable third-party user 120 to access or interact with other systems in environment 100.

In some embodiments, user device 110 or third-party device 125 may be a computer system, e.g., a desktop computer, a laptop computer, a tablet, a smart cellular phone, a smart watch or other electronic wearable, etc. In some embodiments, user device 110 or third-party device 125 may include one or more electronic applications, e.g., a program, plugin, browser extension, etc., installed on a memory of user device 110 or third-party device 125. In some embodiments, the electronic applications may be associated with one or more of the other components in the environment 100.

User device 110 may include a browser module 111 or a graphical user interface (“GUI”) 112. User device 110—or the one or more aspects of user device 110, e.g., browser module 111, GUI 112, etc.—may be configured to obtain data from one or more aspects of environment 100. For example, user device 110 may be configured to receive data from browser module 111, GUI 112 (e.g., via one or more inputs from user 105), application server 115, third-party device 125, DRM-protection system 126, GUI 127 (e.g., via one or more inputs from third-party user 120), data storage 130, etc. User device 110 may be configured to transmit data to one or more aspects of environment 100, e.g., to browser module 111, GUI 112, application server 115, third-party device 125, DRM-protection system 126, GUI 127, data storage 130, etc.

Browser module 111 may be configured to determine whether digital extraction is indicated. In some embodiments, browser module 111 may be configured to detect, analyze, or transmit (e.g., to application server 115) an indication of digital extraction (e.g., screensharing, screenshotting, screen capture, etc.). In some embodiments, browser module 111 may be configured to receive the indication of digital extraction from other aspects of environment 100, such as user device 110, application server 115, data storage 130, etc. In some embodiments, browser module 111 may be configured to detect digital extraction based on indirect measures of digital extraction. For example, browser module 111 may be configured to detect user input(s) that may be indicative of screenshotting, such as simultaneously pressing and releasing the lock button and the volume up button on a social engineer's user device. In some embodiments, browser module 111 may be configured to infer or predict digital extraction may be occurring. For example, browser module 111 may be configured to determine a screensharing application, such as Zoom®, may be operating on a user device (e.g., user device 110) while a user (e.g., user 105) is providing at least one user input (e.g., via GUI 112). Browser module 111 may be configured to determine the indication of digital extraction based on the simultaneous operation of the screensharing application and the accessing sensitive information on user device 110.

Browser module 111 may be configured to obtain data from one or more aspects of environment 100. For example, browser module 111 may be configured to receive data from user device 110, GUI 112 (e.g., via one or more inputs from user 105), application server 115, third-party device 125, DRM-protection system 126, GUI 127 (e.g., via one or more inputs from third-party user 120), data storage 130, etc. Browser module 111 may be configured to transmit data to one or more aspects of environment 100. For example, browser module 111 may be configured to transmit data to user device 110, GUI 112, application server 115, third-party device 125, DRM-protection system 126, GUI 127, data storage 130, etc.

GUI 112 may be configured to cause to output at least one alert (e.g., a first alert, a second alert, a third alert, etc.), etc. GUI 112 may be configured to receive the at least one alert from other aspects of environment 100, such as application server 115, third-party device 125, DRM-protection system 126, etc.

GUI 112 may be configured to obtain data from one or more aspects of environment 100. For example, GUI 112 may be configured to receive data from user device 110, browser module 111, application server 115, third-party device 125, DRM-protection system 126, GUI 127 (e.g., via one or more inputs from third-party user 120), data storage 130, etc. GUI 112 may be configured to transmit data to one or more aspects of environment 100. For example, GUI 112 may be configured to transmit data to user device 110, browser module 111, application server 115, third-party device 125, DRM-protection system 126, GUI 127, data storage 130, etc.

Application server 115 may be configured to determine an accessibility element is associated with a first content element. The accessibility element may be an HTML element, such as an Accessible Rich Internet Application (“ARIA”). The ARIA is a set of roles and attributes that define ways to make web content and web applications more accessible (e.g., to people with disabilities). In some embodiments, the accessibility element (or ARIA) may include at least one of alternative text (“AltText”), accessibility text, semantic HTML, a heading, etc.

Application server 115 may be configured to detect at least one of (i) initiation of at least one HTML modification event, or (ii) receipt of at least one user input associated with the accessibility element or the first content element. In some embodiments, application server 115 may be configured to detect at least one JavaScript event to detect initiation of at least one HTML modification event. The at least one JavaScript event may include at least one of window focus, window blur, editing pane activation (e.g., JavaScript editing pane activation), editing pane deactivation (e.g., JavaScript editing pane deactivation), editing pane width change (e.g., JavaScript editing pane width change), or editing pane height change (e.g., JavaScript editing pane height change). For example, if JavaScript editing pane activation is detected, application server 115 may be configured to detect that at least one HTML modification event may be indicated.

In some embodiments, application server 115 may be configured to detect at least one user input associated with the accessibility element or the first content element. The at least one user input may include hovering, selecting, clicking, etc. in relation to the accessibility element or the first content element. For example, if a user (e.g., user 105) uses an input tool (e.g., a mouse) to hover over the accessibility element, application server 115 may be configured to detect at least one user input may be detected.

Application server 115 may be configured to modify the HTML associated with the content element. In some embodiments, application server 115 may be configured to modify the HTML associated with the content element (e.g., the first content element) to remove the accessibility element. In some embodiments, application server 115 may be configured to modify the HTML associated with the content element based on the at least one user input, upon determining digital extraction is indicated, or upon detecting initiation of the at least one HTML modification event. In some embodiments, application server 115 may be configured to modify the HTML associated with the content element to remove the accessibility element by removing the ARIA from the DOM of the HTML.

In some embodiments, application server 115 may be configured to modify the HTML associated with the content element (e.g., the modified first content element) to insert the accessibility element to generate a modified second content element. In some embodiments, application server 115 may be configured to modify the HTML associated with the modified first content element to insert the accessibility element by inserting the ARIA into the DOM of the HTML. The ARIA that may be inserted to generate the modified second content element may be the ARIA that was removed from the first content element (as discussed above).

Application server 115 may be configured to detect an end event. The end event may be a determination that digital extraction may no longer be indicated. In some embodiments, application server 115 may be configured to detect the end event based on cessation of the at least one user input, cessation of the HTML modification event, etc. For example, if JavaScript editing pane deactivation is determined, application server 115 may be configured to detect the end event.

Application server 115 may be configured to obtain data from one or more aspects of environment 100. For example, application server 115 may be configured to receive data from user device 110, browser module 111, GUI 112 (e.g., via one or more inputs from user 105), third-party device 125, DRM-protection system 126, GUI 127 (e.g., via one or more inputs from third-party user 120), data storage 130, etc. Application server 115 may be configured to transmit data to one or more aspects of environment 100. For example, application server 115 may be configured to transmit data to user device 110, browser module 111, GUI 112, third-party device 125, DRM-protection system 126, GUI 127, data storage 130, etc.

Third-party device 125 may be configured to enable user 120 to access or interact with other systems in the environment 100. Third-party device 125 may include a digital rights management (“DRM”)-protection system 126 (e.g., an analysis system) or a GUI 127. Third-party device 125—or the one or more aspects of third-party device 125, e.g., DRM-protection system 126, GUI 127, etc.—may be configured to obtain data from one or more aspects of environment 100. For example, third-party device 125 may be configured to receive data from user device 110, browser module 111, GUI 112 (e.g., via one or more inputs from user 105), application server 115, DRM-protection system 126, GUI 127 (e.g., via one or more inputs from user 120), data storage 130, etc. Third-party device 125 may be configured to transmit data to one or more aspects of environment 100, e.g., to user device 110, browser module 111, GUI 112 (e.g., via one or more inputs from user 105), application server 115, DRM-protection system 126, GUI 127 (e.g., via one or more inputs from user 120), data storage 130, etc.

DRM-protection system 126 may be configured to implement at least one protective measure. The at least one protective measure may be configured to protect (or safeguard) a content element, sensitive information, etc. The at least one protective measure may include at least one of pausing, locking, canceling, etc. an account (e.g., a financial account) associated with the sensitive information, pausing a current financial transaction, pausing subsequent financial transactions, transmitting the at least one alert (e.g., to GUI 112), etc. In some embodiments, DRM-protection system 126 may be configured to implement the at least one protective measure based on at least one of the at least one user input, detection of the HTML modification event, the indication of digital extraction, the indication of digital extraction, the at least one alert (e.g., the first alert, the second alert, the third alert, etc.), etc. For example, if JavaScript editing pane height change is detected, DRM-protection system 126 may be configured to lock (or freeze) a checking account associated with the checking account number as a precautionary measure.

DRM-protection system 126 may be configured to generate the at least one alert (e.g., the first alert, the second alert, the third alert, etc.) based on at least one user input (e.g., a first user input, a second user input, etc.), the HTML modification event, the intended recipient, the indication of digital extraction, etc. For example, DRM-protection system 126 may be configured to generate the at least one alert upon detecting selection (e.g., via GUI 112) of the accessibility element.

In some embodiments, DRM-protection system 126 may be configured to generate at least one alert (e.g., a first alert, a second alert, a third alert, etc.) based on an intended recipient. A first alert may be generated based on the user (e.g., user 105) being the intended recipient. For example, the first alert may be generated to include a natural language message for user 105 (e.g., “Your data may be at risk,” “Your information may be exposed,” etc.). A second alert may be generated based on the third-party user (e.g., user 120) being the intended recipient. For example, the second alert may be generated to include a natural language message for user 120 (e.g., “User A's data may be compromised,” etc.).

DRM-protection system 126 maybe configured to obtain data from one or more aspects of environment 100. For example, DRM-protection system 126 may be configured to receive data from user device 110, browser module 111, GUI 112 (e.g., via one or more inputs from user 105), application server 115, third-party device 125, GUI 127 (e.g., via one or more inputs from user 120), data storage 130, etc. DRM-protection system 126 may be configured to transmit data to one or more aspects of environment 100, e.g., to user device 110, browser module 111, GUI 112, application server 115, third-party device 125, GUI 127, data storage 130, etc.

GUI 127 may be configured to output the at least one alert (e.g., the first alert, the second alert, the third alert, etc.). For example, GUI 127 may be configured to output the second alert. User 120 may interact with the second alert via GUI 127.

GUI 127 maybe configured to obtain data from one or more aspects of environment 100. For example, GUI 127 may be configured to receive data from user device 110, browser module 111, GUI 112 (e.g., via one or more inputs from user 105), application server 115, third-party device 125, DRM-protection system 126, data storage 130, etc. GUI 127 may be configured to transmit data to one or more aspects of environment 100, e.g., to user device 110, browser module 111, GUI 112, application server 115, third-party device 125, DRM-protection system 126, data storage 130, etc.

Data storage 130 may be configured to receive data from other aspects of environment 100, such as from user device 110, browser module 111, GUI 112 (e.g., via one or more inputs from user 105), application server 115, third-party device 125, DRM-protection system 126, GUI 127 (e.g., via one or more inputs from user 120), etc. Data storage 130 may be configured to transmit data to other aspects of environment 100, such as to user device 110, browser module 111, GUI 112, application server 115, third-party device 125, DRM-protection system 126, GUI 127, etc.

One or more of the components in FIG. 1 may communicate with each other or other systems, e.g., across network 140. In some embodiments, network 140 may connect one or more components of environment 100 via a wired connection, e.g., a USB connection between user device 110 and data storage 130. In some embodiments, network 140 may connect one or more aspects of environment 100 via an electronic network connection, for example a wide area network (WAN), a local area network (LAN), personal area network (PAN), a content delivery network (CDN), or the like. In some embodiments, the electronic network connection includes the internet, and information and data provided between various systems occurs online. “Online” may mean connecting to or accessing source data or information from a location remote from other devices or networks coupled to the Internet. Alternatively, “online” may refer to connecting or accessing an electronic network (wired or wireless) via a mobile communications network or device. The Internet is a worldwide system of computer networks—a network of networks in which a party at one computer or other device connected to the network may obtain information from any other computer and communicate with parties of other computers or devices. The most widely used part of the Internet is the World Wide Web (often-abbreviated “WWW” or called “the Web”). A “website page,” a “portal,” or the like generally encompasses a location, data store, or the like that is, for example, hosted or operated by a computer system so as to be accessible online, and that may include data configured to cause a program such as a web browser to perform operations such as send, receive, or process data, generate a visual display or an interactive interface, or the like. In any case, the connections within the environment 100 may be network, wired, any other suitable connection, or any combination thereof.

Although depicted as separate components in FIG. 1, it should be understood that a component or portion of a component in the environment 100 may, in some embodiments, be integrated with or incorporated into one or more other components. For example, application server 115 may be integrated in browser module 111. In some embodiments, operations or aspects of one or more of the components discussed above may be distributed amongst one or more other components, e.g., one or both of browser module 111 or application server 115.

In some embodiments, some of the components of environment 100 may be associated with a common entity, while others may be associated with a disparate entity. For example, browser module 111 and application server 115 may be associated with a common entity (e.g., an entity with which user 105 has an account) while data storage 130 may be associated with a third party (e.g., a provider of data storage services). Any suitable arrangement or integration of the various systems and devices of the environment 100 may be used.

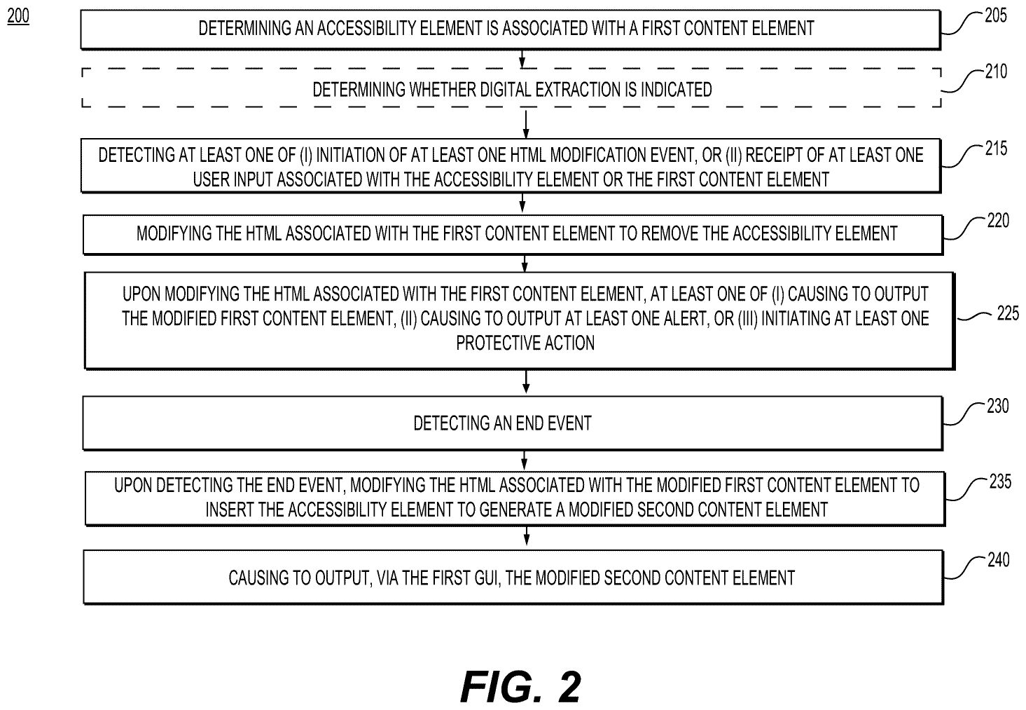

FIG. 2 depicts an exemplary method for obfuscating an accessibility element using DRM protections, according to one or more embodiments. As depicted in method 200 of FIG. 2, at step 205, it may be determined that an accessibility element is associated with a first content element (e.g., via application server 115). In some embodiments, the accessibility element may be determined to be associated with a first content element based on a scan of the HTML associated with the first content element. The scanning may detect at least one of the following: plain text within the content element, text within an HTML, an attribute on the element (AltText, ARIA, etc.), text within another element that's associated with the first content element via ARIA techniques, any of these same methods applied to a visually hidden element which is redundant to the first content element or only accessed via assistive technology, etc.

Optionally, at step 210, it may be determined whether digital extraction is indicated (e.g., via browser module 111). In some embodiments, the indication of digital extraction may be determined based on at least one indirect factor, such as user inputs, enabled settings, concurrently operating applications, etc. For example, if it is detected that Zoom® is operating on a user device (e.g., on user device 110) while a user (e.g., user 105) is accessing sensitive information, digital extraction may be indicated.

In some embodiments, a trained machine learning model may be configured to determine whether digital extraction is indicated. For example, the trained machine learning model may predict whether digital extraction is indicated based on the at least one indirect factor, the user input (e.g., the first user input, the second user input, etc.), a content element (e.g., a first content element, a second content element, etc.), etc.

At step 215, at least one of (i) initiation of at least one HTML modification event, or (ii) receipt of at least one user input associated with the accessibility element or the first content element may be detected (e.g., via application server 115). In some embodiments, detection of the initiation of at least one HTML modification event may include detecting at least one JavaScript event. The at least one JavaScript event may include at least one of window focus, window blur, editing pane activation (e.g., JavaScript editing pane activation), editing pane deactivation (e.g., JavaScript editing pane deactivation), editing pane width change (e.g., JavaScript editing pane width change), or editing pane height change (e.g., JavaScript editing pane height change). For example, if JavaScript editing pane activation is detected, at least one HTML modification event may be indicated.

In some embodiments, detection of at least one user input associated with the accessibility element or the first content element may include detection of at least one of hovering, selecting, clicking, etc. in relation to the accessibility element or the first content element. For example, if a user (e.g., user 105) uses an input tool (e.g., a mouse) to hover over the accessibility element, at least one user input may be detected.

At step 220, the HTML associated with the first content element may be modified to remove the accessibility element (e.g., via application server 115). In some embodiments, the HTML associated with the first content element may be modified based on the at least one user input, upon determining digital extraction is indicated, or upon detecting initiation of the at least one HTML modification event. In some embodiments, modifying the HTML associated with the first content element to remove the accessibility element may include removing an ARIA from a Document Object Model (“DOM”) of the HTML.

At step 225, upon modifying the HTML associated with the first content element, at least one of (i) causing to output the modified first content element, (ii) causing to output at least one alert, or (iii) initiating at least one protective action. In some embodiments, the modified first content element may be caused to be output (e.g., via GUI 112) such that the accessibility element is no longer accessible.

In some embodiments, the at least one alert (e.g., a first alert, a second alert, etc.) may be generated (e.g., via DRM-protection system 126) based on the intended recipient. In some embodiments, the first alert may be generated based on the user (e.g., user 105) being the intended recipient. For example, the first alert may be generated to may be generated to include a natural language message for user 105 (e.g., “Your data may be at risk,” “Your information may be exposed,” etc.). In some embodiments, the second alert may be generated based on the third-party user (e.g., third-party user 120) being the intended recipient. For example, the second alert may be generated to include a natural language message for user 120 (e.g., “User A's data may be compromised,” etc.).

In some embodiments, the at least one alert may be generated (e.g., via DRM-protection system 126) based on at least one of the detected at least one user input, the detected HTML modification event, or the indication of digital extraction. For example, the first alert may be generated in response to receipt of the determination that digital extraction is indicated and transmitted to the user (e.g., to user device 110 associated with user 105). In another example, the second alert may be generated in response to receipt of the determination that digital extraction is indicated and transmitted to the third-party user (e.g., to third-party device 125 associated with third-party user 120).

In some embodiments, the at least one protective measure may be initiated (e.g., via DRM-protection system 126) based on receipt of at least one user input, detection of the HTML modification event, the indication of digital extraction, the at least one alert (e.g., the first alert, the second alert, the third alert, etc.), etc. As discussed herein, the at least one protective measure may include at least one of pausing, locking, canceling, etc. an account (e.g., a financial account) associated with the sensitive information, pausing a current financial transaction, pausing subsequent financial transactions, transmitting the at least one alert (e.g., to GUI 112), etc. For example, where a user (e.g. user 105) is attempting to authorize a wire transfer, the current financial transaction and subsequent financial transactions may be paused upon the determination that an HTML modification event is detected.

At step 230, an end event may be detected (e.g., via application server 115). The end event may be a determination that digital extraction may no longer be indicated. In some embodiments, detection of the end event may be based on cessation of the at least one user input, cessation of the HTML modification event, etc. For example, if JavaScript editing pane deactivation is determined, the end event may be detected.

At step 235, upon detecting the end event, the HTML associated with the modified first content element may be modified to insert the accessibility element to generate a modified second content element (e.g., via application server 115). In some embodiments, modifying the HTML associated with the modified first content element to insert the accessibility element may include inserting an ARIA into the DOM of the HTML. The ARIA that may be inserted in step 235 may be the ARIA that was removed in step 220.

At step 240, the modified second content element may be caused to output (e.g., via GUI 112). For example, the modified second content element may be caused to output such that the accessibility element may be caused to be output and is accessible (e.g., to user 105 via GUI 112).

Conventionally, DRM is capable of protecting videos. However, where HTML includes accessibility element, DRM protections may be circumvented if a social engineer were to utilize the accessibility element to gain access to sensitive information, even if the sensitive information is being protected by DRM technologies. As such, the techniques described herein provide novel methods of protecting sensitive information using DRM techniques, e.g., by utilizing DRM protections for accessibility elements.

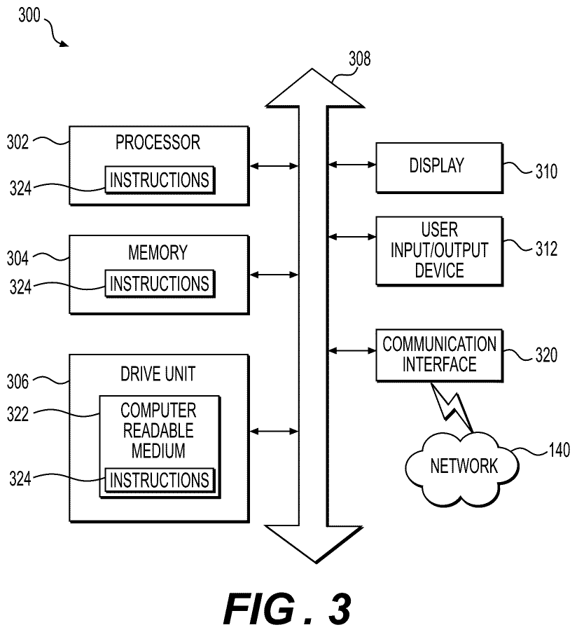

FIG. 3 depicts a simplified functional block diagram of a computer 300 that may be configured as a device for executing the methods disclosed here, according to exemplary embodiments of the present disclosure. For example, the computer 300 may be configured as a system according to exemplary embodiments of this disclosure. In various embodiments, any of the systems herein may be a computer 300 including, for example, a data communication interface 320 for packet data communication. The computer 300 also may include a central processing unit (CPU) 302, in the form of one or more processors, for executing program instructions. The computer 300 may include an internal communication bus 308, and a storage unit 306 (such as ROM, HDD, SDD, etc.) that may store data on a computer readable medium 322, although the computer 300 may receive programming and data via network communications. The computer 300 may also have a memory 304 (such as RAM) storing instructions 324 for executing techniques presented herein, although the instructions 324 may be stored temporarily or permanently within other modules of computer 300 (e.g., processor 302 or computer readable medium 322). The computer 300 also may include input and output ports 312 or a display 310 to connect with input and output devices such as keyboards, mice, touchscreens, monitors, displays, etc. The various system functions may be implemented in a distributed fashion on a number of similar platforms, to distribute the processing load. Alternatively, the systems may be implemented by appropriate programming of one computer hardware platform.

Program aspects of the technology may be thought of as “products” or “articles of manufacture” typically in the form of executable code or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Steps may be added or deleted to methods described within the scope of the present invention. The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

What is claimed is:

1. A method for obfuscating an accessibility element using digital rights management (“DRM”) protections, the method comprising:
determining, via an application server, the accessibility element is associated with a first content element;
receiving, via a first graphical user interface (“GUI”), at least one user input associated with the accessibility element or the first content element, wherein the at least one user input includes at least one of hovering, selecting, or clicking;
modifying, via the application server, a HyperText Markup Language (“HTML”) associated with the first content element to remove the accessibility element; and
causing to output, via the first GUI, the modified first content element such that the accessibility element is no longer caused to be output.

2. The method of claim 1, further comprising:
determining, via a browser module, whether digital extraction is indicated; and
upon determining digital extraction is indicated and based on the at least one user input, modifying the HTML associated with the first content element to remove the accessibility element via the application server.

3. The method of claim 1, further comprising:
based on the at least one user input, generating a first alert via an analysis system; and
causing to output the first alert via the first GUI.

4. The method of claim 1, further comprising:
based on the at least one user input, generating a second alert via an analysis system; and
causing to output the second alert via a second GUI.

5. The method of claim 1, further comprising:
upon modifying the HTML associated with the first content element to remove the accessibility element, initiating at least one protective measure via an analysis system.

6. The method of claim 1, wherein determining the accessibility element is associated with a first content element further comprises scanning, via the application server, the HTML associated with the first content element to detect at least one of alternative text (“AltText”), accessibility text, semantic HTML, or a heading.

7. The method of claim 1, wherein modifying the HTML associated with the first content element to remove the accessibility element includes removing an Accessible Rich Internet Applications (“ARIA”) from a Document Object Model (“DOM”) of the HTML.

8. The method of claim 1, further comprising:
detecting, via the application server, initiation of at least one HTML modification event, wherein the at least one HTML modification event includes at least one JavaScript event; and
upon detecting initiation of the at least one HTML modification event, modifying the HTML associated with the first content element to remove the accessibility element via the application server.

9. The method of claim 8, wherein the at least one JavaScript event includes at least one of window focus, window blur, JavaScript editing pane activation, JavaScript editing pane deactivation, JavaScript editing pane width change, or JavaScript editing pane height change.

10. The method of claim 1, further comprising:
detecting an end event, wherein the end event includes cessation of the at least one user input;
upon detecting the end event, modifying the HTML associated with the modified first content element to insert the accessibility element to generate a modified second content element via the application server; and
causing to output, via the first GUI, the modified second content element such that the accessibility element is caused to be output.

11. A system, the system comprising:
at least one memory storing instructions; and
at least one processor operatively connected to the memory, and configured to execute the instructions to perform operations for obfuscating an accessibility element DRM protections, the operations including:
determining, via an application server, the accessibility element is associated with a first content element;
receiving, via a first graphical user interface (“GUI”), at least one user input associated with the accessibility element or the first content element, wherein the at least one user input includes at least one of hovering, selecting, or clicking;
modifying, via the application server, a HTML associated with the first content element to remove the accessibility element; and
causing to output, via the first GUI, the modified first content element such that the accessibility element is no longer caused to be output.

12. The system of claim 11, further comprising:
determining, via a browser module, whether digital extraction is indicated; and
upon determining digital extraction is indicated and based on the at least one user input, modifying the HTML associated with the first content element to remove the accessibility element via the application server.

13. The system of claim 11, the operations further comprising:
based on the at least one user input, generating a first alert via an analysis system; and
causing to output the first alert via the first GUI.

14. The system of claim 11, the operations further comprising:
based on the at least one user input, generating a second alert via an analysis system; and
causing to output the second alert via a second GUI.

15. The system of claim 11, the operations further further comprising:
upon modifying the HTML associated with the first content element to remove the accessibility element, initiating at least one protective measure via an analysis system.

16. The system of claim 11, wherein determining the accessibility element is associated with a first content element further comprises scanning, via the application server, the HTML associated with the first content element to detect at least one of alternative text (“AltText”), accessibility text, semantic HTML, or a heading.

17. The system of claim 11, wherein modifying the HTML associated with the first content element to remove the accessibility element includes removing an ARIA from a DOM associated with the HTML.

18. The system of claim 11, the operations further comprising:
detecting, via the application server, initiation of at least one HTML modification event, wherein the at least one HTML modification event includes at least one JavaScript event, wherein the at least one JavaScript event includes at least one of window focus, window blur, JavaScript editing pane activation, JavaScript editing pane deactivation, JavaScript editing pane width change, or JavaScript editing pane height change; and
upon detecting initiation of the at least one HTML modification event, modifying the HTML associated with the first content element to remove the accessibility element via the application server.

19. The system of claim 11, the operations further comprising:
detecting an end event, wherein the end event includes cessation of the at least one user input;
upon detecting the end event, modifying the HTML associated with the modified first content element to insert the accessibility element to generate a modified second content element via the application server; and
causing to output, via the first GUI, the modified second content element such that the accessibility element is caused to be output.

20. A method for obfuscating an accessibility element using digital rights management (“DRM”) protections, the method comprising:
determining, via an application server, the accessibility element is associated with a first content element by scanning a HTML associated with the first content element to detect at least one of alternative text (“AltText”), accessibility text, semantic HTML, or a heading;
detecting, via the application server, at least one of:
(i) initiation of at least one HTML modification event, wherein the at least one HTML modification event includes at least one JavaScript event, wherein the at least one JavaScript event includes at least one of window focus, window blur, JavaScript editing pane activation, JavaScript editing pane deactivation, JavaScript editing pane width change, or JavaScript editing pane height change, or
(ii) receipt, via a first graphical user interface (“GUI”), at least one user input associated with the accessibility element or the first content element, wherein the at least one user input includes at least one of hovering, selecting, or clicking;
modifying, via the application server, the HTML associated with the first content element to remove the accessibility element by removing an ARIA from a DOM associated with the HTML;
causing to output, via the first GUI, the modified first content element such that the accessibility element is no longer caused to be output;
detecting an end event, wherein the end event includes cessation of at least one of: (i) the at least one HTML modification event or (ii) the at least one user input;
upon detecting the end event, modifying the HTML associated with the modified first content element to insert the accessibility element to generate a modified second content element via the application server; and
causing to output, via the first GUI, the modified second content element such that the accessibility element is caused to be output.
